(19) United States
(12) Patent Application Publication
(10) Pub. No.: US 2026/0109065 A1
(43) Pub. Date: Apr. 23, 2026

(54) COMPOSITE BLADE

(71) Applicant: B LINE INTL. INC., Valencia, CA (US)

(72) Inventor: Andrew BEILIN, Valencia, CA (US)

(21) Appl. No.: 19/342,401

(22) Filed: Sep. 26, 2025

Related U.S. Application Data
(60) Provisional application No. 63/833,097, filed on Oct. 23, 2024.

(51) Int. Cl. B26D 1/00; E01H 4/02

(52) U.S. Cl. CPC B26D 1/0006; E01H 4/023; B26D 2001/002; B26D 2001/0053

(57) ABSTRACT

The blade comprises: a body portion; and an edge portion, the edge portion defining an edge of the blade and being secured adhesively to the body part. The body portion can be defined by a relatively low density material and the edge portion can be defined by a relatively high density material. The body portion and edge portion can each be defined by a respective metal, the metals of the body portion and edge portion being dissimilar. The adhesive can be a two-part methacrylate structural adhesive. The body portion can be 6061 aluminum and the edge portion can be 440C stainless.

### CROSS-REFERENCE TO RELATED APPLICATIONS

This application claims priority to U.S. Provisional Patent Application Ser. No. 63/833,09, filed Oct. 23, 2025, which is incorporated by reference into the Detailed Description herein below in their entirety.

### FIELD

The invention relates to the field of ice resurfacing blades.

### SUMMARY OF THE INVENTION

Forming one aspect of the invention is a blade comprising: a body portion; and an edge portion, the edge portion defining an edge of the blade and being secured adhesively to the body portion.

According to other aspects, the blade can be a blade for ice resurfacing, the body portion can defined by a relatively low density material and the edge portion can be defined by a relatively high density material, the body portion and edge portion can each be defined by a respective metal, the metals of the body portion and edge portion being dissimilar, the adhesive can be a two-part methacrylate structural adhesive and the body portion can be 6061 aluminum and the edge portion can be 440C stainless.

Advantages, features and characteristics of the present invention will become apparently upon a review of the following detailed description with reference to the appended drawings, the latter being briefly described hereinafter.

### BRIEF DESCRIPTION OF THE DRAWINGS

In the drawings:

FIG. 1 is a bottom view of a blade constructed accorded to an exemplary embodiment of the invention;

FIG. 2 is a side view of the blade of FIG. 1; and

FIG. 3 is an enlarged view of detail 3 of FIG. 2.

### DETAILED DESCRIPTION

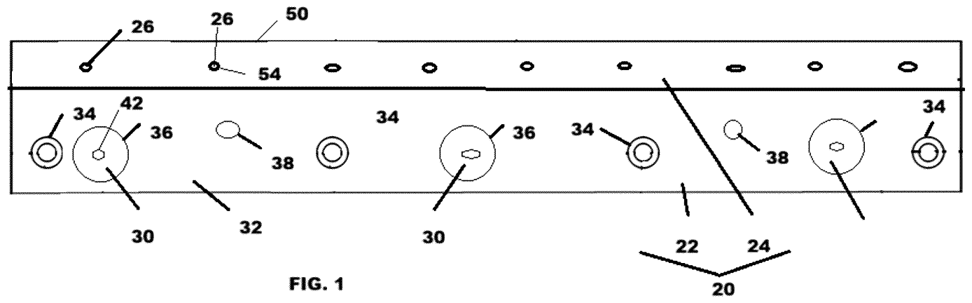

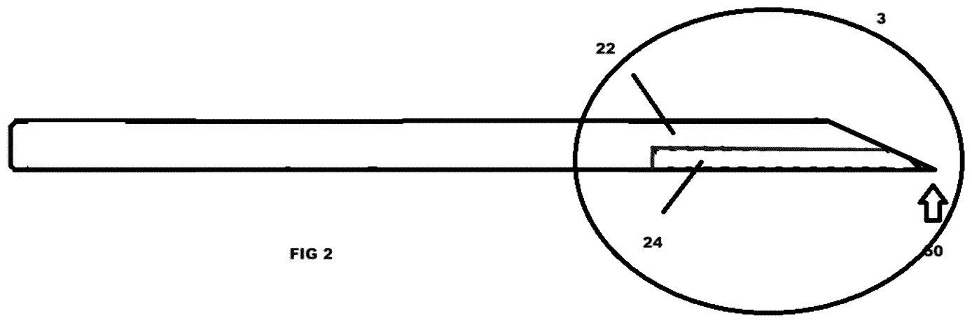

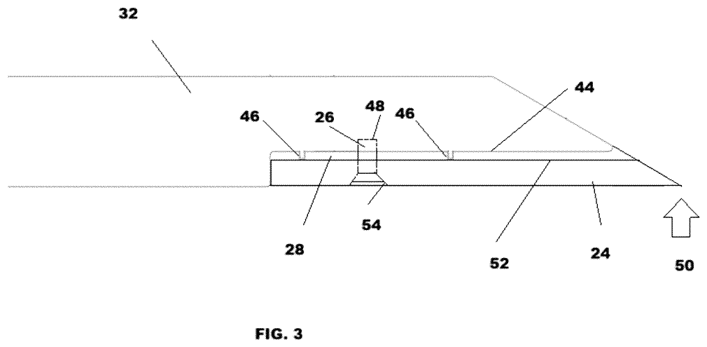

An ice blade 20 according to an example embodiment of the invention is shown in FIGS. 1-3 and will be seen to be of the type used in the resurfacing of ice rinks and to include a body portion 22, an edge portion 24, a plurality of thread locking screws 26 and an adhesive layer 28.

The body portion 22 includes a plurality of inserts 30 and a body part 32. The inserts 30 are steel. The body part is 6061 aluminum and has defined therein a plurality of throughholes 34, a plurality of sockets 36, a plurality of threaded lifting bores 38 and an inset 40. The throughholes 34 are configured to permit the ice blade to be mounted to an ice resurfacing machine in a conventional fashion (not shown). Each socket 36 is in secure receipt of an insert 30 by a countersunk machine screw 42. The threaded lifting bores 38 are spaced on the upper surface of the ice blade 20 to facilitate lifting. The inset 40 has defined therein a surface 44 from which a pair of ridges 46 protrude and in which a plurality of threaded mounting bores 48 are defined. The ridges 46 are spaced apart about 1 inch, are each about 0.03″ wide and each protrude from the surface 44 about 0.06 inch.

The edge portion 24 is 440C stainless, defines a cutting edge 50, has a surface 52 which abuts the ridges 46 and has a plurality of countersunk throughbores 54 defined therein.

Each thread locking screw 26 passes through a countersunk throughbore 54 in edge portion 24 and into a threaded mounting bore 48 in the body part 32.

The adhesive layer 28 is cured Henkels Loctite AA H8500 and occupies the space defined between the body portion 22 and the edge portion 24 by the ridges 46.

### Manufacture

The ice blade of FIGS. 1-3 was manufactured as follows:
body portion 22 and edge portion 24 were machined and manufactured by a fabrication shop using conventional milling techniques
thereafter, the surfaces of the edge portion and body portion that receive adhesive were roughened, the edge portion by laser etching and the body portion using a DA sander with a 60 grit pad
the Loctite product was applied to surface 44
the edge portion 24 was placed in the inset 40
the thread locking screws 26 were inserted through the throughbores 54 and tightened into the threaded mounting bores 48, thereby drawing the edge portion tightly against the ridges

### EXPERIMENTAL

The blade of FIGS. 1-3 was used for ice resurfacing more than 300 times without sharpening. In contrast, low cost blades available in the marketplace sometimes need resurfacing within about 100 cuts.

### VARIATIONS

Whereas a specific embodiment is herein shown and described, variations are possible. Without limitation in this regard, the body portion and edge portion can be constructed of other materials, the adhesive need not be of the two-part methacrylate structural adhesive type and the blade need not be for ice resurfacing. Without limitation in this regard, Infinity bond MMA H8500 has proven useful with the same materials. Accordingly, the invention should be understood to be limited only by the accompanying claims.

1. A blade comprising:
a body portion; and
an edge portion, the edge portion defining an edge of the blade and being secured adhesively to the body part.

2. The blade of claim 1, wherein the body portion is defined by a relatively low density material and the edge portion is defined by a relatively high density material.

3. The blade of claim 1, wherein the body portion and edge portion are each defined by a respective metal, the metals of the body portion and edge portion are dissimilar.

4. The blade of claim 1, wherein the adhesive is a two-part methacrylate structural adhesives.

5. The blade of claim 1, wherein the body portion is 6061 aluminum and the edge portion is 440C stainless.
